(19) United States
(12) Patent Application Publication
(10) Pub. No.: US 2002/0045699 A1
(43) Pub. Date: Apr. 18, 2002

(54) Solution rubbers having nonpolar side groups

(76) Inventors: Thomas Scholl, Bergisch Gladbach (DE); Jurgen Trimbach, Koln (DE)

Correspondence Address: BAYER CORPORATION, PATENT DEPARTMENT, 100 BAYER ROAD, PITTSBURGH, PA, 15205, US

(21) Appl. No.: 09/736,505

(22) Filed: Dec. 13, 2000

(30) Foreign Application Priority Data
Dec. 20, 1999 (DE) 19961522.5

(51) Int. Cl. C08F 8/34

(52) U.S. Cl. 524/572; 525/332.8; 525/332.9; 525/333.1; 525/333.2; 525/350

(57) ABSTRACT

The present invention relates to rubbers based on diolefins that are characterized in that they have a content of 0.1 to 40 wt. %, relative to the total quantity of rubber, of non-polar lateral, saturated, linear, branched or cyclic hydrocarbons bound via sulfur atoms containing 1 to 22 carbon atoms or aromatic hydrocarbon radicals containing 6 to 22 carbon atoms, wherein the rubbers are produced by polymerization in solution.

### FIELD OF THE INVENTION

The present invention relates to rubbers produced by solution polymerization and based on diolefins having nonpolar lateral hydrocarbon radicals bound via sulfur atoms (S-diene rubbers) and also to the use of said rubbers for producing vulcanized rubbers having improved dynamic damping, improved mechanical strength and improved abrasion behavior. In particular, the rubbers according to the present invention are suitable for producing fully reinforced rubber moldings, in particular tires, that have an extreme thermal and mechanical load-bearing capacity, a high wet-skid resistance, a low roll resistance and a high abrasion resistance.

### BACKGROUND OF THE INVENTION

Numerous routes have been investigated for producing motor vehicle tires having lower roll resistance, improved wet-skid resistance, lower abrasion and higher thermal stability. The use of anionically polymerized solution rubbers containing double bonds, such as solution polybutadienes and solution styrene/butadiene rubbers proved particularly advantageous. The advantages are, inter alia, the controllability of the vinyl content and the glass transition temperature associated therewith, a favorable cis/trans double-bond relationship and the molecular branching. In practical use, this results in particular advantages in the relationship of the wet-skid resistance and roll resistance of the tire. Thus, U.S. Pat. No. 5,227,425 describes the production of tire treads from a solution SBR rubber and silicic acid. One object of the present invention is to provide solution rubbers having a suitable content of particularly inexpensive and effective side groups that result in better tire properties. CD

Methods of producing hydroxyalkyl- or carboxyalkyl-containing solution polybutadiene rubbers and solution styrene/butadiene rubbers are described, inter alia, in DE-A 2,653,144 and EP-A 464 478. Due to the content of polar hydroxyl and carboxyl groups, these rubbers differ from nonpolar rubbers in mixing behavior and in miscibility.

Furthermore, the reaction of emulsion polybutadiene rubbers, NBR and SBR emulsion rubbers with alkylmercaptans is described in Rubber Plast. Age 38 (1957), pages 592 to 599 and also pages 708 to 719. However, rubbers modified in this way are used, according to the cited literature, only for oil-resistant industrial rubber products. If the modified SBR emulsion rubbers are used in tires and tire treads, however, it is found that the physical properties described above are achieved only to an inadequate extent, if at all.

### SUMMARY OF THE INVENTION

The object of the present invention is therefore to provide rubbers that are based on diolefins, that are produced by solution polymerization and that result in the improvement of the tire properties described above.

Surprisingly, it was found that solution rubbers produced from diolefins having a certain content of nonpolar, saturated hydrocarbon radicals have particularly favorable properties for producing, in particular, tires.

The present invention therefore provides rubbers based on diolefins that are characterized in that they have a content of 0.1 to 40 wt. %, relative to the total quantity of rubber, of nonpolar lateral saturated linear, branched or cyclic hydrocarbon radicals bound via sulfur atoms and containing 1 to 22 carbon atoms or aromatic hydrocarbon radicals containing 6 to 22 carbon atoms, wherein the rubbers are produced by polymerization in solution.

### DETAILED DESCRIPTION OF THE INVENTION

According to the present invention, the rubbers are preferred that have a content of 0.5 to 25 wt. %, relative to the total quantity of rubber, of the above-mentioned nonpolar lateral hydrocarbon radicals bound via sulfur atoms.

Preferred rubbers according to the present invention contain, in addition, 0.1 to 50 wt. %, preferably 10 to 40 wt. %, relative to the total quantity of rubber, of vinyl aromatic monomers incorporated by polymerization. In addition, the rubbers according to the present invention may have a content of 1,2-bound diolefins (vinyl content) of 10 to 70 wt. %, preferably 20 to 60 wt. %, and a content of 1,4-trans-bound diolefins of 0 to 50 wt. %, preferably 10 to 40 wt. %, relative to the total amount of rubber.

The most preferred rubbers according to the present invention are those that have a content of the above-mentioned hydrocarbon radicals of 1.0 to 15 wt. %, a content of vinyl aromatic monomers incorporated by polymerization of 10 to 40 wt. %, a content of diolefins of 89 to 45 wt. %, wherein the content of 1,2-bound diolefins (vinyl content) is in the range from 10 to 60 wt. % and the content of 1,4-trans-bound diolefins is in the range from 10 to 40 wt. %. The above-mentioned contents again relate to the total quantity of rubber and add up to 100 wt. %.

According to the present invention, 1,3-butadiene, isoprene, 1,3-pentadiene, 2,3-dimethylbutadiene, 1-vinyl-1,3-butadiene and/or 1,3-hexadiene, in particular, serve, as diolefins, to synthesize the rubbers. 1,3-Butadiene and isoprene are preferred.

As examples of vinyl aromatic monomers that can be used for the polymerization, mention may be, for example, made of: styrene, o-, m- and p-methylstyrene, p-tert-butylstyrene, α-methylstyrene, vinylnaphthalene, divinylbenzene, trivinylbenzene and/or divinylnaphthalene. Styrene is preferred.

The rubbers according to the present invention have molecular weights (number average) of about 50,000 to 2,000,000, preferably 100,000 to 1,000,000, glass transition temperatures of −110° C. to +20° C., preferably −60° C. to 0° C., and also Mooney viscosities ML 1+4 (100° C.) of 10 to 200, preferably of 30 to 150. In the case of the rubbers according to the present invention, the diolefin is preferably present in 1,4-trans form in less than 40 wt. %, relative to the total quantity of rubber.

In addition to the nonpolar side groups described above, the rubbers according to the present invention may also contain additional functional groups that are known in rubber technology, for example amino, carboxylic ester, carboxamide and/or sulfonic acid groups. In particular, the rubbers according to the present invention may contain hydroxyl and/or carboxylic acid groups or their salts, preferably in a quantity of 0.1 to 2 wt. %, relative to the total quantity of rubber. This quantity range relates also to the other known, but mentioned functional groups.

The rubbers according to the present invention are produced by conventional polymerization in solution in an inert organic solvent suitable for the purpose by means of an anionic catalyst, for example based on alkali metal, such as n-butyllithium. In addition, the known randomizers and control agents for controlling the microstructure of the rubber can be used in said polymerization. Such anionic solution polymerizations are known and are described, for example, in I. Franta, Elastomers and Rubber Compounding Materials; Elsevier 1989, pages 73-74, 92-94 and in Houben-Weyl, Methoden der Organischen Chemie (Methods of Organic Chemistry), Thieme Verlag, Stuttgart, 1987, volume E 20, pages 114-134.

According to the present invention, the nonpolar lateral hydrocarbon groups are introduced into the rubber preferably after polymerization of the monomers used has taken place in the solvent used by reacting the polymers obtained preferably in the presence of suitable free-radical starters with mercaptans of the following formula:

H—S—R,

in which

R stands for a nonpolar saturated linear, branched or cyclic C₁-C₂₂-hydrocarbon radical or a C₆-C₂₂-aromatic hydrocarbon radical.

Suitable as aromatic mercaptans are both those containing an aromatic hydrocarbon radical, an arylalkyl radical and those containing an alkylaryl radical.

The mercaptans to be used may, of course, also be substituted, in particular in the aromatic radicals.

Preferred mercaptans are methyl-, ethyl-, propyl-, butyl-, hexyl-, cyclohexyl-, octyl-, decyl-, dodecyl- and octadecyl mercaptan and also thiophenol. Most preferred are octyl-, decyl-, dodecyl- and octadecyl mercaptan and also thiophenol.

The mercaptans H—S—R react by addition to the double bonds, preferably to the vinyl double bonds of the rubber.

The content of side groups (II) can be determined by known methods, such as, for example, spectroscopy or elemental analysis.

According to the present invention, the reaction of the mercaptans with the solution rubbers can be carried out in an inert solvent, for example, hydrocarbons, such as pentane, hexane, cyclohexane, benzene and/or toluene, at temperatures of approximately 40 to 150° C. in the presence of free-radical starters, for example, peroxides, in particular, acyl peroxides, such as dilauroyl peroxide and dibenzoyl peroxide and ketal peroxides, such as di-tert-butyl peroxytrimethylcyclohexane, furthermore by means of azo initiators, such as azobisisobutyronitrile, benzpinacol silyl ethers or in the presence of photoinitiators and visible or UV light.

The rubbers according to the present invention can, of course, also contain the fillers known and used in the rubber industry; these comprise both the active and the inactive fillers. Mention is to be made of:

highly dispersed silicas produced, for example, by precipitation of solutions of silicates or flame hydrolysis of silicon halides having specific surface areas of 5-1000, preferably 20-400 m²/g (BET surface area) and having primary particle sizes of 10-400 nm. The silicas can optionally also be present as mixed oxides with other metal oxides, such as Al, Mg, Ca, Ba, Zn, Zr and Ti oxides;

synthetic silicates, such as aluminum silicate, alkylene earth silicate, such as magnesium silicate or calcium silicate, having BET surface areas of 20-400 m²/g and primary particle diameters of 10-40 nm;

natural silicates, such as kaolin and other naturally occurring silicas;

glass fibers and glass-fiber products (mats, strands) or glass microbeads;

metal oxides, such as zinc oxide, calcium oxide, magnesium oxide, aluminum oxide;

metal carbonates, such as magnesium carbonate, calcium carbonate, zinc carbonate;

metal hydroxides, such as, for example, aluminum hydroxide, magnesium hydroxide;

blacks. The blacks used in this connection are produced by the lampblack, furnace or gas black methods and have BET surface areas of 20-200 m²/g, for example SAF, ISAF, HAF, FEF or GPF blacks;

rubber gels;

rubber powder that has been obtained, for example, by grinding vulcanized rubbers.

Preferably, highly dispersed silicas and/or blacks are used as fillers.

The fillers mentioned can be used alone or as a mixture. In a most preferred embodiment, the rubber mixtures contain, as fillers, a mixture of bright fillers, such as highly dispersed silicas, and blacks, wherein the mixing ratio of bright fillers to blacks is 1:0.05 to 20, preferably 1:0.1 to 10.

Of course, the rubbers according to the present invention can also be used with rubbers other than those described above, for example with natural rubber and also synthetic rubbers.

Preferred synthetic rubbers are described, for example, by W. Hoffinan, Kautschuk-technologie (Rubber Technology), Gentner Verlag, Stuttgart, 1980 and I. Franta, Elastomers and Rubber Compounding Materials, Elsevier, Amsterdam, 1989. They comprise, inter alia,

BR—polybutadiene

ABR—butadiene/C₁-C₄-alkyl acrylate copolymers

CR—polychloroprene

IR—polyisoprene

SBR—styrene/butadiene copolymers having styrene contents of 1-60, preferably 20-50 wt. %

IIR—isobutylene/isoprene copolymers

NBR—butadiene/acrylonitrile copolymers having acrylonitrile contents of 5-60, preferably 10-40 wt. %

HNBR—partially hydrogenated or completely hydrogenated NBR rubber

EPDM—ethylene/propylene-diene copolymers

and also mixtures of said rubbers. Of interest for the production of motor vehicle tires are, in particular, natural, rubber, emulsion SBR and also solution SBR rubbers having a glass transition temperature above −50° C. that may optionally have been modified with silyl ethers or other functional groups according to EP-A 447 066, polybutadiene rubber having a high 1,4-cis content (>90%) that have been produced using catalysts based on Ni, Co, Ti or Nd, and also polybutadiene rubber having a vinyl content of up to 75% and also mixtures thereof.

Of course, the rubber mixtures according to the present invention may also contain other rubber additives that are used, for example, for the widespread crosslinking of vulcanizates produced from the rubber mixtures or that improve the physical properties of the vulcanizates produced from the rubber mixtures according to the present invention for special application purposes thereof.

Sulfur or sulfur-providing compounds or peroxides are used as additional cross-linking reagents. Preferred compounds are sulfur or sulfur-providing compounds in quantities of 0.01 to 3 parts by weight, relative to the rubber. In addition, as mentioned, the rubber mixtures according to the present invention may contain further additives, such as the known reaction accelerators, antioxidants, heat stabilizers, light stabilizers, anti-ozonants, processing aids, reinforcing resins, for example phenol resins, steel-cord adhesives, such as, for example, silica/resorcinol/hexamethylenetetramine or cobaltnaphthenate, plasticizers, tackifiers, propellants, dyestuffs, pigments, waxes, extenders, organic acids, retarding agents, metal oxides and also activators.

The rubber additives according to the present invention are used in the conventional, known quantities, wherein the quantity used depends on the subsequent application purpose of the rubber mixtures. Quantities of rubber additives in the range from 2 to 70 parts by weight, relative to 100 parts by weight of rubber, are, for example, conventional.

As mentioned above, additional rubbers may also be added to the rubbers according to the present invention. Their quantity is normally in the range from 0.5 to 70, preferably 10 to 50 wt. %, relative to the total quantity of rubber in the rubber mixture. The quantity of rubbers additionally added again depends on the respective application purpose of the rubber mixtures according to the present invention.

The use of additional filler activators is particularly advantageous for the rubber mixtures according to the present invention that are filled with highly active silicas. Preferred filler activators are sulfur-containing silyl ethers, in particular, bis(trialkoxysilylalkyl)polysulfides, such as those described in DE-A 2,141,159 and DE-A 2,255,577. In addition, oligomeric and/or polymeric sulfur-containing silyl ethers in accordance with the description in DE-A 4,435,311 and EP-A 670 347 are suitable. Moreover, mercaptoalkyltrialkoxy-silane, in particular mercaptopropyltriethoxysilane and thiocyanatoalkylsilyl ether (see DE-A 19 544 469), amino-group-containing silyl ethers, such as, for example, 3-aminopropyltriethoxysilane and N-oleyl-N-propyl-trimethoxysilane and also trimethylolpropane can be used. The filler activators are used in conventional quantities, i.e. in quantities of 0.1 to 15 parts by weight, relative to 100 parts by weight of rubber.

The rubber mixtures according to the present invention can be produced, for example, by mixing the solution rubbers according to the present invention carrying nonpolar side groups with the appropriate fillers and sulfur-free crosslinking agents in suitable mixing equipment, such as compounders, rolls or extruders.

The present invention also provides for the use of the rubber mixtures according to the present invention to produce vulcanizates that serve in turn to produce highly reinforced rubber moldings, in particular for the production of tires.

### EXAMPLE 1

25 g of stearylmercaptan and 1 g of dilauroyl peroxide were added at 80° C. to a solution of 500 g of solution SBR rubber, Buna VSL 5025-0 (Bayer AG, content of bound styrene 25 wt. %, content of 1,2-bound butadiene 50 wt. %) in 4 l of cyclohexane. The mixture was then stirred for 6 hours at 80° C. 2.5 g of the stabilizer Vulkanox® 4020 (Bayer AG) were then added and the solvent was distilled off with steam. After drying at 70° C. in vacuo, 526 g of a colorless rubber having a Mooney viscosity ML 1+4 (100° C.) 100 was obtained. Sulfur content: 0.5 wt. %. Content of —S—C₁₈H₃₇ groups: 4.8 wt. %. Content of 1,4-trans-bound butadiene: 14 wt. %, content of 1,2-bound butadiene: 45 wt. % (determined by means of FT-IR). Glass transition temperature: −18° C.

### EXAMPLES 2-7

The procedure was as in Example 1, but the 25 g of stearylmercaptan used therein was replaced by the quantities of alkylmercaptans stated in the table below:

| | | Content of | |
|---|---|---|---|
| Example | | -S-alkyl groups | Glass transition |
| No. | Mercaptan | in final product | temperature |
| 2 | 12.5 g stearylmercaptan | 2.4 wt. % | −17° C. |
| 3 | 12.5 g 1-dodecylmercaptan | 2.4 wt. % | −17° C. |
| 4 | 25 g 1-dodecylmercaptan | 4.8 wt. % | −16° C. |
| 5 | 12.5 g 1-octylmercaptan | 2.4 wt. % | −16° C. |
| 6 | 25 g 1-octylmercaptan | 4.8 wt. % | −15° C. |
| 7 | 12.5 g 1-butylmercaptan | 4.8 wt. % | −14° C. |

The content of 1,4-trans-bound butadiene was approximately 14 wt. % in each case.

### EXAMPLE 8

The following substances were mixed in a 1.5 l compounder (speed 60 rev/min, degree of filling 65%, starting temperature 70° C., duration: 5 minutes). The mixtures were then removed, and sulfur and accelerator were added on a roll at a roll temperature of 40° C.

| | Com- | | | |
|---|---|---|---|---|
| | pari- | Ex- | Ex- | Ex- |
| | son | ample | ample | ample |
| Mixing Components: | A | 8.1 | 8.2 | 8.3 |

Mixed in the 1.5 l. compounder:

| | | | | |
|---|---|---|---|---|
| Solution SBR Buna VSL | 70 | 0 | 0 | 0 |
| 5025-0 (Bayer AG) | | | | |
| Solution SBR according to | 0 | 70 | 0 | 0 |
| Example 1 | | | | |
| Solution SBR according to | 0 | 0 | 70 | 0 |
| Example 3 | | | | |
| Solution SBR according to | 0 | 0 | 0 | 70 |
| Example 5 | | | | |
| Polybutadiene rubber | 30 | 30 | 30 | 30 |
| Buna CB 24 (Bayer AG) | | | | |
| Silica Vulkasil S (Bayer AG) | 70 | 70 | 70 | 70 |
| Stearic Acid | 1 | 1 | 1 | 1 |
| Zinc Oxide RS (Bayer AG) | 2.5 | 2.5 | 2.5 | 2.5 |
| Aromatic petroleum | 37.5 | 37.5 | 37.5 | 37.5 |
| Enerthene 1849-1 (BP) | | | | |
| Anti-ozonate wax | 1.5 | 1.5 | 1.5 | 1.5 |
| Antilux 654 (Rhein Chemie) | | | | |
| Anti-oxidant vulkanox | 1 | 1 | 1 | 1 |
| 4020 (Bayer) | | | | |
| Bis(triethoxysilylpropyl) | 5.6 | 5.6 | 5.6 | 5.6 |
| tetrasulfide Si 69 (Degussa) | | | | |

Mixed on the roll:

| | | | | |
|---|---|---|---|---|
| Sulfenamide accelerator | 1.8 | 1.8 | 1.8 | 1.8 |
| vulkacit CZ (Bayer) | | | | |
| Guanidine accelerator | 2 | 2 | 2 | 2 |
| Vulkacit D (Bayer) | | | | |
| Sulfur | 1.5 | 1.5 | 1.5 | 1.5 |
| Mixture viscosity ML 1 + 4 | 40 | 45 | 47 | 45 |
| (100° C.) | | | | |
| The mixtures were | | | | |
| vulcanized at 170° C. | | | | |
| Vulcanizing time: 20 minutes | | | | |

Vulcanizate properties:

| | | | | |
|---|---|---|---|---|
| Modulus at 100% elongation | 2.3 | 2.1 | 2.2 | 2.2 |
| (MPa) | | | | |
| Modulus at 300% elongation | 8.4 | 8.6 | 8.6 | 8.6 |
| (MPa) | | | | |
| Tensile strength (MPa) | 15.5 | 16 | 15.6 | 16.6 |
| Elongation at break | 460 | 450 | 450 | 470 |
| Hardness at 23° C. (Shore A) | 64 | 63 | 62 | 63 |
| Impact resilience at 23° C. (%) | 32 | 31 | 32 | 31 |
| Impact resilience at 70° C. (%) | 53 | 54 | 55 | 54 |
| Difference between impact | 21 | 23 | 23 | 23 |
| resilience at 23° C. and 70° C. | | | | |
| Tear propagation resistance | 21.5 | 31.9 | 32 | 40.9 |
| in N/mm (DIN 52515) | | | | |
| Abrasion in ccm | 78 | 61 | 62 | 61 |
| (DIN 53516) | | | | |

The test results confirm the improved mechanical properties, achieved by the nonpolar side groups, of the solution rubbers according to the present invention, and, in particular, marked advantages are exhibited in the abrasion behavior, the tear propagation resistance and also in the dynamic damping.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Rubbers based on diolefins, wherein said rubbers comprise a content of 0.1 to 40 wt. %, relative to the total quantity of rubber, of nonpolar lateral saturated linear, branched or cyclic hydrocarbon radicals bound via sulfur atoms and containing 1 to 22 carbon atoms or aromatic hydrocarbon radicals containing 6 to 22 carbon atoms, wherein said rubbers are produced by polymerization in solution.

2. Rubbers according to claim 1, wherein the rubbers contain 0.1 to 50 wt. %, relative to the total quantity of rubber, of vinyl aromatic monomers incorporated by polymerization.

3. Rubbers according to claim 1, wherein said rubbers comprise a content of 1,2-bound diolefins of 10 to 70 wt. %, relative to the total quantity of rubber.

4. Rubbers according to claim 1, wherein said rubbers comprise 0.1 to 2 wt. %, relative to the total quantity of rubber, of lateral hydroxyl groups and/or carboxyl groups.

5. Rubbers according to claim 1, wherein said rubbers comprise 10 to 800 parts by weight of fillers, relative to 100 parts by weight of rubber, and also optionally natural rubber and other synthetic rubbers, rubber additives and crosslinking agents.

6. Highly reinforced rubber moldings comprising rubbers based on diolefins, wherein said rubbers comprise a content of 0.1 to 40 wt. %, relative to the total quantity of rubber, of nonpolar lateral saturated linear, branched or cyclic hydrocarbon radicals bound via sulfur atoms and containing 1 to 22 carbon atoms or aromatic hydrocarbon radicals containing 6 to 22 carbon atoms, wherein said rubbers are produced by polymerization in solution.

7. Highly reinforced rubber moldings according to claim 6 wherein said rubber molding is a tire.
